(19) United States
(12) Patent Application Publication
(10) Pub. No.: US 2008/0029679 A1
(43) Pub. Date: Feb. 7, 2008

(54) Theft Deterrent Bracket

(75) Inventors: Giovanni Benedetti, Ayrshire (GB); Graham Sharp, Renfrewshire (GB); Stephen Slack, North Lanarkshire (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Benedetti International PLC

(21) Appl. No.: 11/628,420

(22) PCT Filed: May 16, 2005
(86) PCT No.: PCT/GB05/01877

§ 371 Date: Jun. 29, 2007

(30) Foreign Application Priority Data
Jun. 5, 2004 (GB) 0412621.5

(51) Int. Cl. E05B 73/00

(52) U.S. Cl. 248/553; 248/551; 70/63

(57) ABSTRACT

A theft deterrent bracket for holding and presenting at least one item from a wall or panel, the bracket including at least one socket for receiving a portion of said item. The casing comprises: a) a locking component positioned within the casing and comprising a locking element having first and second configurations; the locking element being sized and shaped to, in the first configuration, engage with a corresponding element positioned on the item and fixedly retain the item within the casing, and, in the second configuration, not engage with the corresponding element of the item; b) releasing component to move the locking component into the second configuration; and c) protecting component to shield the locking component and the releasing component from direct access or interference. The bracket is provided with affixing component for attaching it to a panel.

This invention relates to a bracket for holding and presenting at least one item on a panel such as a wall panel or a wall in such a manner as to prevent or deter theft of the item. The invention is particularly, but not exclusively, applicable to the holding and presentation of items containing first aid materials such as plasters.

Following health and safety regulations it is now compulsory in some countries to provide first aid items in the workplace for the benefit of the employees. These are to be used in case of medical need or emergencies and are usually freely available. Some of these items, such as plasters, are usually provided in self-contained boxes that are safely stored in a bigger container (i.e. first aid box). However, when the work carried out in the workplace is mostly manual in nature, minor wounds may occur frequently and it is desirable to make such basic first aid items quickly and readily accessible. In particular, it is known that small boxes of such items are provided on wall-mounted brackets. When a box of items has been emptied, it is removed from the bracket and replaced by a new box full of the first aid items.

One of the problems encountered when freely displaying small items such as plasters and the like, is theft.

One solution that is known to reduce such theft is to permanently secure the sterile wrapped items like plasters within their container so that, to get hold of one item, one has to tear away part of the individual sterile wrapper of the item. This has no consequences when the item is to be immediately used but will deter people from taking more items than readily needed. Such a device is described in U.S. Pat. No. 6,050,413.

Whilst such devices are effective to prevent the pilfering of individual items, it does not prevent the theft of the whole box of items from the displaying bracket. This is not only undesirable because of the cost of repeatedly replacing such boxes, but also for safety reasons as the first aid items may not be available when needed.

It could also be conceived to secure the box of items to the bracket through the use of chain-and-padlock devices. This method is unsatisfactory for several reasons. Firstly, a chain and padlock is expensive and would have to be bought separately by the user. Moreover, if the padlock key was inadvertently lost, the empty box would remain locked to the bracket until the chain and/or padlock is forcibly cut open. Also, displaying such devices may have adverse psychological effects on employees, as it can be perceived as a lack of trust and lowers employees' morale. Therefore the theft deterrent bracket should advantageously be provided in an inconspicuous manner and become apparent only when a person is trying to remove the box of items from its holding bracket.

Accordingly, there is a need of a device to prevent the unauthorized removal of such boxes of items from the holding bracket. Such a device should be of low cost and low maintenance as the items to be protected are not of any particular value. It should be understood that one of the objects of this invention is to provide an anti-theft bracket designed to deter passers-by from simply getting hold of the items. It is however not an object of the invention to provide a high security device, but only to render the removal of the box difficult so that occasional pilferers are deterred.

### STATEMENT OF THE INVENTION

An object of the invention is a theft deterrent bracket for holding and presenting at least one item from a panel or wall. The bracket according to the invention comprises a body having affixing means for attaching said body to a panel and at least one socket and a rigid casing for receiving a portion of said item. The socket comprises:
a) locking means positioned within said casing and comprising a locking element having first and second configurations; said locking element is sized and shaped to, in the first configuration, engage with a corresponding element positioned on said item and fixedly retain said item within said casing, and, in the second configuration, not engage with said corresponding element of said item;
b) releasing means actuable to move the locking means into the second configuration; and
c) protecting means to shield the locking means and the releasing means from direct access or interference.

Advantageously the locking means are provided by two similar locking elements which are preferably provided on opposite sides of the socket. It is also preferred that each locking element be resiliently mounted onto said casing. It is further preferred that each locking element comprises a flap member which can be deflected between said first and second configuration. Advantageously a locking tooth is positioned at the extremity of the flap member.

The orientation of the flap member is such that a reasonable attempt to forcibly remove the said item from the socket will not cause deflection of the flap.

Preferably the socket comprises a front panel, a back panel, a bottom panel, and two side wall panels which are sized and shaped to receive a portion of the item in a close fit relationship.

It is further preferred that the releasing means includes an aperture positioned in the socket to allow access to said locking means. The releasing means may also comprise an angled contact surface.

The protecting means preferably comprises an element provided within said aperture and which is provided with a pre-determined profile sized and shaped to co-operate with a complementary profile provided on a distinct key element.

In a particularly preferred embodiment the bracket of the invention comprises three aligned sockets.

It is further preferred that the affixing means comprises one or more screw holes each located within the socket or one of the sockets.

The bracket of the invention may advantageously be made of rigid plastic.

The bracket of the invention is particularly designed to hold one or more containers of first aid items.

Another object of the invention is a key element which comprises a handle and at least one elongated shaft which is sized and shaped to co-operate with the bracket of the invention described above. Advantageously the key element comprises two elongated shafts to simultaneously disengage two such features. It is also preferred that the key element comprises a V-shaped groove at the extremity of each shaft.

Yet another object of the invention is a bracket and key assembly, or kit, which comprises the bracket and the key element as described above.

### BRIEF DESCRIPTION OF THE DRAWINGS

An embodiment of the invention will now be described by way of example only and with reference to the drawings in which:

FIG. 1 is an isometric view from above of a device according to the invention which comprises a bracket and a removal key inserted within said bracket.

FIG. 2 shows the device of FIG. 1 viewed from below.

FIG. 3 is an isometric view to an enlarged scale of part of the bracket of FIG. 1 (key and container not shown), partially sectioned, on line A-A of FIG. 1.

FIG. 4 is a partial cross-sectional view of the bracket of FIG. 1 (key and container not shown) taken along line B-B of FIG. 1.

FIG. 5 is a partial cross-sectional view of the bracket and container of FIG. 1 (key shown prior to insertion) taken along line C-C.

FIG. 6 is a partial cross-sectional view of the bracket of FIG. 1 (key partially inserted) taken along line D-D.

FIG. 7 is an isometric view of the key.

### DETAILED DESCRIPTION OF ONE EMBODIMENT OF THE INVENTION

The bracket and key of the invention are conveniently made from a strong or rigid plastic material that cannot be easily deformed or shattered such as acrylonitrile-butadiene-styrene (ABS). Conveniently the key may be made from acetal (POM) which through its low frictional properties, makes insertion of the key easier, and reduces the likelihood of wear on either part. Both elements can be manufactured according to conventional techniques like moulding and are conveniently each a one-piece element.

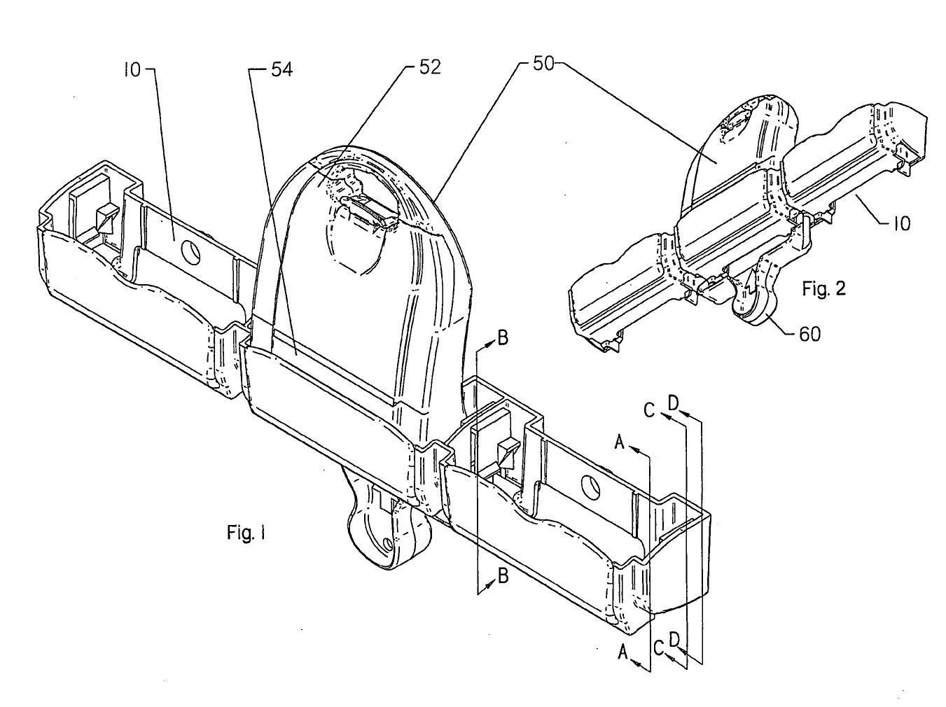

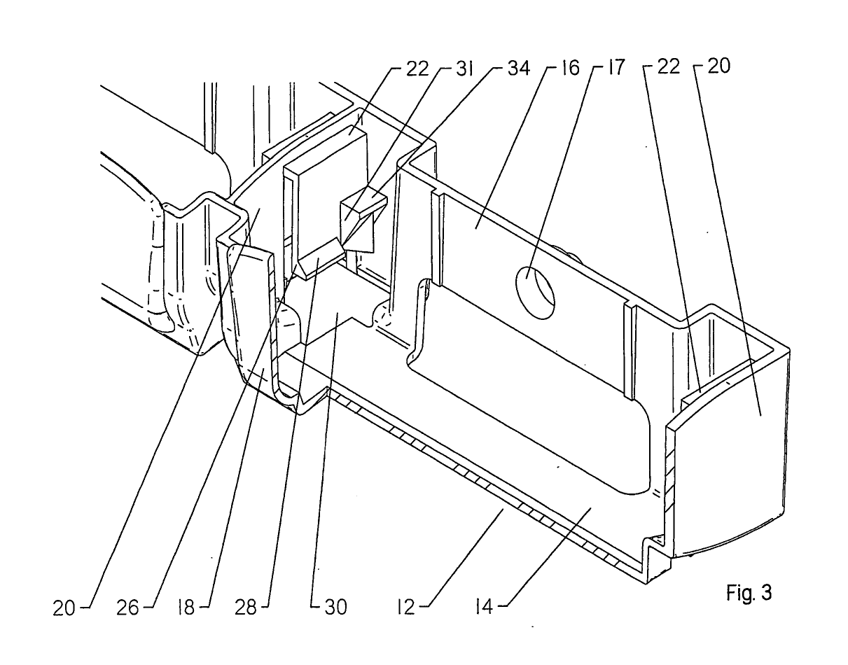

A bracket 10 is best shown in FIG. 1. According to a preferred variant of the invention the bracket 10 is designed to hold three distinct containers 50 side-by-side and comprises a row of three distinct similar sockets 12. FIG. 1 only shows one such container 50 being held within the bracket 10. This arrangement is particularly suitable to display a combination of the most usually frequently needed first aid items such as plasters, cleansing wipes etc. The items are accessible by means not affected by the bracket such as a front door panel 52 which may pivot around a horizontal hinge 54.

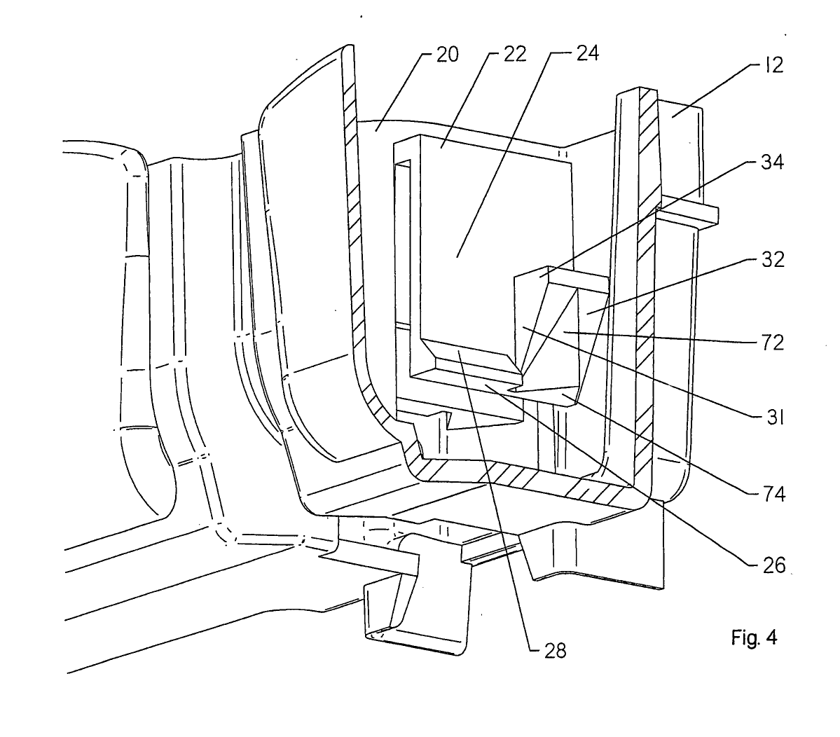

As best shown in FIG. 3, each socket 12 has a bottom panel 14, a back panel 16, a front panel 18 and two side panels 20. The overall size and shape of the socket 12 is conveniently designed to closely fit the bottom part of a container 50. Conveniently such tight fitting arrangement prevents the container 50 from being moved in any direction other then upwardly. The back panel 16 comprises a screw hole 17 to allow the mounting of the bracket 10 onto a wall. Of course, other known means of securing the bracket 10 to a surface, like a wall surface, are encompassed by the present invention but it is advantageous to position such means so as they are hidden or difficult to access when the bracket 10 is in use and displaying the containers 50. Thus, according to this particular embodiment, the screw hole 17 is positioned in the back panel 16 so that the screw securing the bracket 10 will be concealed by the container 50 when positioned within the socket 12.

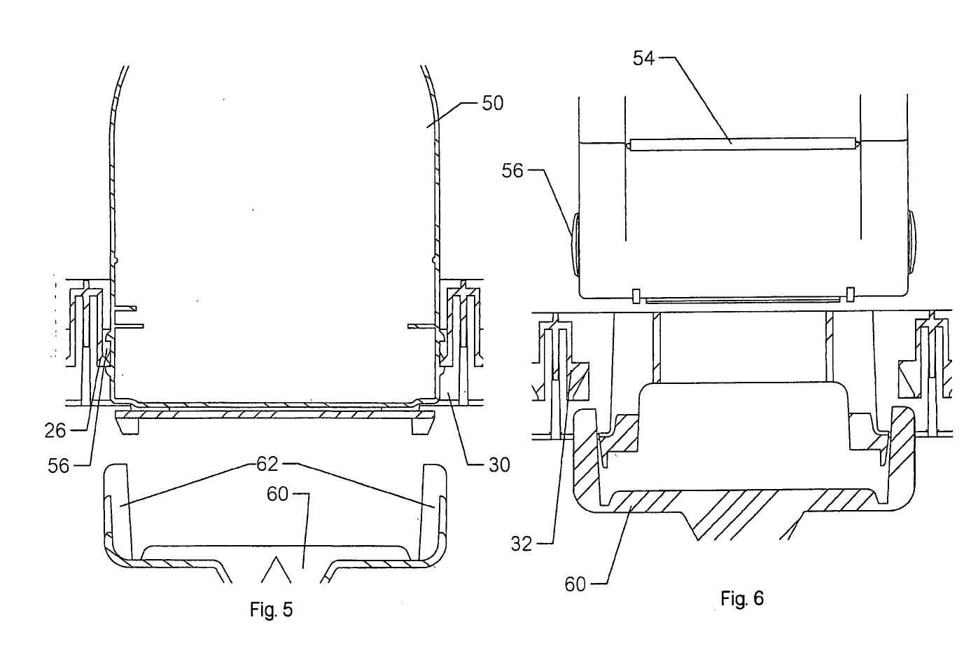

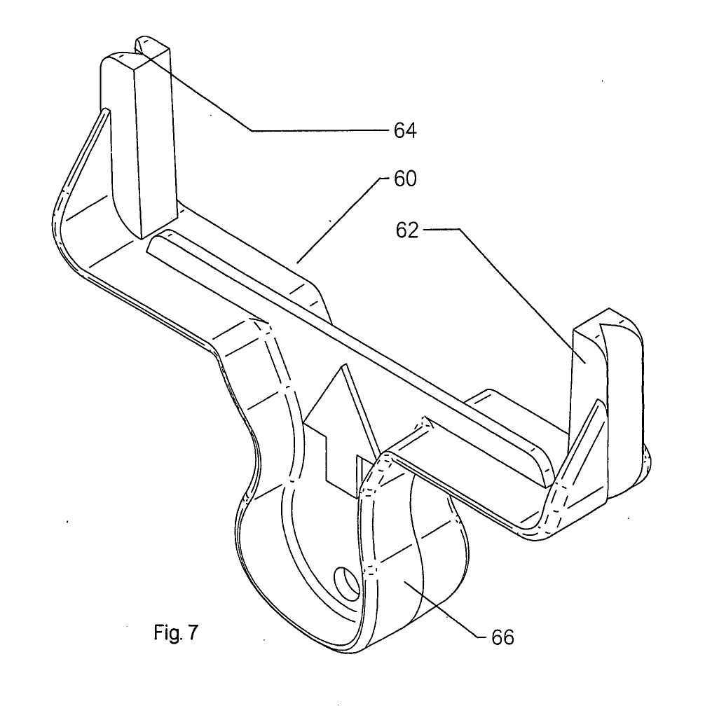

Two identical locking elements 22 are positioned on either side of the interior of socket 12. As can be best seen in FIG. 4, a locking flap 24 is mounted on the side panel 20. The flap 24 is resiliently mounted. In this particular embodiment the properties of the material used (rigid plastic) combined with the reverse L-shape of the flap 24 allows the extremity of the flap 24 to be deflected inwardly in the direction of the side panel 20 to which it is connected. However other resilient means, such as springs and the like could also be used. A protruding locking tooth 26 is provided of the flap 24. The locking tooth 26 is sized and shaped to lodge within a small recess 56 provided on the side of the small container 50. The locking tooth 26 is further provided with a top angled surface 28. When the container 50 is inserted in the socket 12, the bottom of the container 50 will contact the surface 28 and, due to the angle, a perpendicular (or lateral) force will be applied to this surface 28 and the resiliently mounted flap 24 will be deflected away from the bottom of the container 50. When the recess 56 of the container 50 comes opposite to the locking tooth 26, said tooth 26 will lodge within the recess 56 and the flap 24 will regain its resting position (see FIG. 5).

If the container 50 is lifted upward, the locking teeth 26 provided on both sides of the socket 12 will abut on the ledges defined by the recesses 56 of the container 50 and prevent further movement.

To release the container 50 from the socket 12, a key element 60 has been provided. It is sized and shaped to move the locking element 22 from the first locking position to a second (deflected) position thus freeing the container 50 from the casing 12. In this embodiment, the deflection of the flap 24 is eased by the provision on the flap 24 of a releasing element 31. On the releasing element 31 is provided an angled surface 32 connected, and preferably integral with, a portion of the flap 24. The angled surface 32 projects upwardly and outwardly from the flap 24 so that a vertically upward force exerted on this surface 32 will have a perpendicular component which will force the flap 24 to deflect perpendicularly (or laterally) and away from the container 50 thus releasing it. In this particular disposition the key member 60 comprises an elongated shaft 62 which can access and deflect the flap 24 by passing through an aperture 30 provided in the bottom panel 14 of the socket 12. As the socket 12 is advantageously provided with two symmetric locking elements 22, the key member 60 can be provided with two symmetric shafts 62 and take the overall shape of a fork as best shown in FIG. 7. For ease of manipulation a handle 66 is advantageously provided on the key member 60.

It should be noted that providing the bracket 10 with a locking means 22 on each side has the result that a deflecting action has to be applied simultaneously on both locking elements 22 to free the container 50. This feature by itself makes the removal of the container 50 without an appropriate tool difficult as it relies on a co-ordinate deflection of both locking means 22.

To avoid the container 50 being freed by using any elongated tools or piece of material of suitable size, such as a pencil or a screwdriver, protecting means are provided to increase the difficulty of accessing and deflecting the locking member 22. The protecting means is provided on the locking elements 22 to block access to the deflecting portion of the locking element 22 (in this case the lower part of the flap 24), and in particular the angled surface 32, except to a tool of particular and pre-determined profile.

As can be seen in FIGS. 3 and 4, in this particular embodiment the blocking means comprises the triangular projection 72, which is conveniently provided onto the angled surface 32. Both elements 32 and 72 are connected to the locking means 22. Of course their particular dimensions are determined so that they may come in close proximity (or even in contact) with the container 50 but do not hinder the positioning or removal of said container 50 when the locking means 22 are disengaged.

It should be noted that both the top surface 34 of the releasing element and the bottom surface 74 of the triangular projection 72 project substantially perpendicularly-from the locking flap 24. Thus one trying to gain access to the releasing element 31 without the proper tool will apply either a downward force to said top surface 34 or and an upward force to bottom surface 74. This will not deflect the flap 24, as such force will not exert any significant lateral force component necessary to achieve deflection of the flap 24.

In effect the projection 72 (together with the container's wall) determines the internal profile of (at least part) of the aperture 30. To gain access to the angled released surface 32 through aperture 30 the end portion of the shaft 62 must be provided with a complementary profile. In this particular case the corresponding profile is a V-shaped groove 64.

Once a container 50 is locked into position within a socket 12 by the protruding locking tooth 34, the releasing element 31 is only accessible through the aperture 30. To release the container 50, the key member 60 is positioned beneath the bracket 10 and lifted upward so that the profiled ends of the elongated shafts 62 are aligned with and slide along the triangular projection 72 and the angled release surface 32. Because of the angle provided on-the release surface 32 the upward motion of both shaft 62 will laterally deflect the flaps 24, thus disengaging both locking teeth 34 and releasing the container 50 which can be removed from the socket 12.

It should be understood that the device of the invention is designed to act more as a deterrent than as a fool-proof anti-theft device. For example, as the bracket is usually made from plastic it is possible to forcibly remove the container 50 from the bracket 10 by exerting a sufficient amount of force so as to break or damage the locking device 22 of the bracket 10. Alternatively, a replica of the key member 60 could be designed. However it can be seen that very few people will effectively go to such an extent to possess a container of low cost, first aid items which this bracket is designed to hold. Thus the aim of the invention is to provide a simple and low cost bracket-and-key assembly that prevents direct removal of the containers or object they are designed to present.

Although described with particular references to small boxes of first aid items it will be obvious that the bracket and key of the invention may be used to secure other kind of items.

The embodiments within the specification provide an illustration of embodiments of the invention and should not be construed to limit the scope of the invention. The skilled artisan readily recognizes that many other embodiments are encompassed by the invention. The relevant disclosures of references cited herein are specifically incorporated by reference.

1. A theft deterrent bracket for holding and presenting at least one item from a wall or panel, said bracket comprising a body having affixing means for attaching said body to a wall or panel and at least one socket and a rigid casing for receiving a portion of said item, said socket comprising:
a) locking means positioned within said casing and provided by two similar locking elements having first and second configurations; said locking elements being sized and shaped to, in the first configuration, engage with a corresponding element positioned on said item and fixedly retain said item within said casing, and, in the second configuration, not engage with said corresponding element of said item, wherein each locking element is resiliently mounted onto said casing and comprises a flap member which can be deflected between said first and second configuration and wherein a locking tooth is positioned at the extremity of said flap member;
b) releasing means actuable to move said locking means into said second configuration; and
c) protecting means to shield said locking means and said releasing means from direct access or interference.

2. The bracket of claim 1, wherein said locking elements are provided on opposite sides of said socket.

3. The bracket of claim 1 or 2, wherein said socket comprises a front panel, a back panel, a bottom panel, and two side wall panels which are sized and shaped to receive said portion of said item in a close fit relationship.

4. The bracket of any one of claims 1 to 3, wherein said releasing means includes an aperture positioned in the socket to allow access to said locking means.

5. The bracket of any one of claims 1 to 4, wherein said releasing means comprises an angled contact surface.

6. The bracket of claim 4, wherein said protecting means comprises an element provided within said aperture and which is provided with a pre-determined profile sized and shaped to co-operate with a complementary profile provided on a distinct key element.

7. The bracket of any one of claims 1 to 6, which comprises three aligned sockets.

8. The bracket of any one of claims 1 to 7, wherein said affixing means comprises one or more screw holes each located within the socket or one of the sockets.

9. The bracket of any one of claims 1 to 8, wherein said bracket is made of rigid plastic.

10. The bracket of any one of claims 1 to 9, wherein the item is a container of first aid items.

11. A key element which comprises a handle and at least one elongated shaft which is sized and shaped to co-operate with the bracket of any one of claims 1 to 10.

12. The key element of claim 11, which comprises two elongated shafts.

13. The key element of claims 11 or 12, which comprises a V-shaped groove at the extremity of each shaft.

14. A bracket and key assembly comprising the bracket of any one of claims 1 to 10 and the key element of any one of claims 11 to 13.

15-18. (canceled)
